(19) United States
(12) Patent Application Publication
(10) Pub. No.: US 2015/0108393 A1
(43) Pub. Date: Apr. 23, 2015

(54) SINTERED BODY AND INDUCTOR

(71) Applicant: MURATA MANUFACTURING CO., LTD., Kyoto (JP)

(72) Inventors: Mitsuru ODAHARA, Nagaokakyo-shi (JP); Yukie SHIMIZU, Nagaokakyo-shi (JP)

(73) Assignee: MURATA MANUFACTURING CO., LTD., Kyoto (JP)

(21) Appl. No.: 14/504,709

(22) Filed: Oct. 2, 2014

(30) Foreign Application Priority Data
Oct. 21, 2013 (JP) 2013-218313

(51) Int. Cl. H01F 1/01; H01F 27/255

(52) U.S. Cl. CPC H01F 1/01; H01F 27/255
USPC 252/62.58; 252/62.56; 252/62.59

(57) ABSTRACT

A sintered body contains Z-type hexagonal ferrite, Bi₂O₃, and a glass material as starting materials. The additive ratio by weight of the Bi₂O₃ to the Z-type hexagonal ferrite in the starting materials is within a range from 5:100 to 7:100. The sintered body is obtained by sintering of the starting materials and contains the Z-type hexagonal ferrite as a main phase.

### CROSS REFERENCE TO RELATED APPLICATIONS

This application claims benefit of priority to Japanese Patent Application No. 2013-218313 filed Oct. 21, 2013, the entire content of which is incorporated herein by reference.

### TECHNICAL FIELD

The present disclosure relates to a sintered body and an inductor, and more particularly to a sintered body and an inductor using Z-type hexagonal ferrite.

### BACKGROUND

With the recent demand for higher-frequency electronic components, for example, Z-type hexagonal ferrite as disclosed by Japanese Patent Laid-Open Publication No. 2005-57156 draws attention as a material for a sintered body used in an inductor. An inductor using Z-type hexagonal ferrite has a feature that the inductance value and the Q-value in a high-frequency area are good.

However, such an inductor using Z-type hexagonal ferrite has a problem that the inductance value and the Q-value change significantly with changes in temperature, that is, have high temperature-dependency.

### SUMMARY

An object of the present disclosure is to provide a sintered body of Z-type hexagonal ferrite and an inductor using the sintered body of which inductance value and Q-value have low temperature-dependency.

A sintered body according to a first embodiment of the present disclosure comprises Z-type hexagonal ferrite, Bi₂O₃ and a glass material as starting materials. The additive ratio by weight of the Bi₂O₃ to the Z-type hexagonal ferrite in the starting materials is within a range from 5:100 to 7:100. The sintered body is obtained by sintering of the starting materials and contains the Z-type hexagonal ferrite as a main phase.

An inductor according to a second embodiment of the present disclosure comprises the sintered body.

### BRIEF DESCRIPTION OF THE DRAWINGS

FIG. 1 is a perspective view of an inductor according to an embodiment.

FIG. 2 is an exploded view of the inductor according to the embodiment.

FIG. 3 is a diagram indicating the relation between the additive amount of a glass material and the temperature-dependency of inductance.

### DETAILED DESCRIPTION

An inductor according to an embodiment of the present disclosure and a production method of the inductor will be hereinafter described.

### Structure of the Inductor

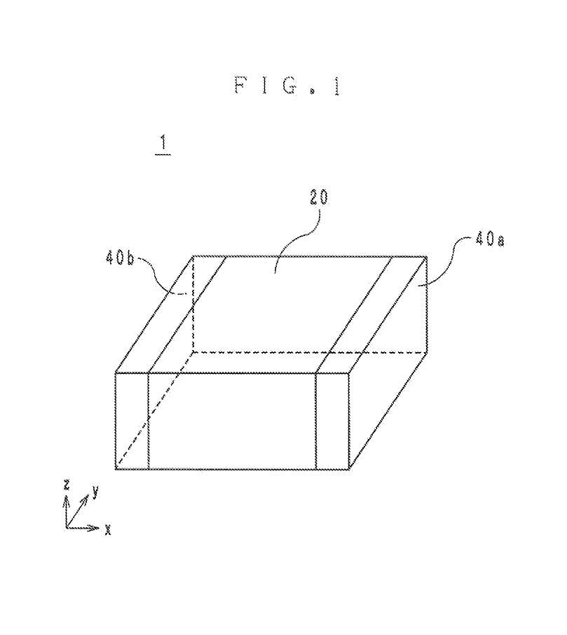

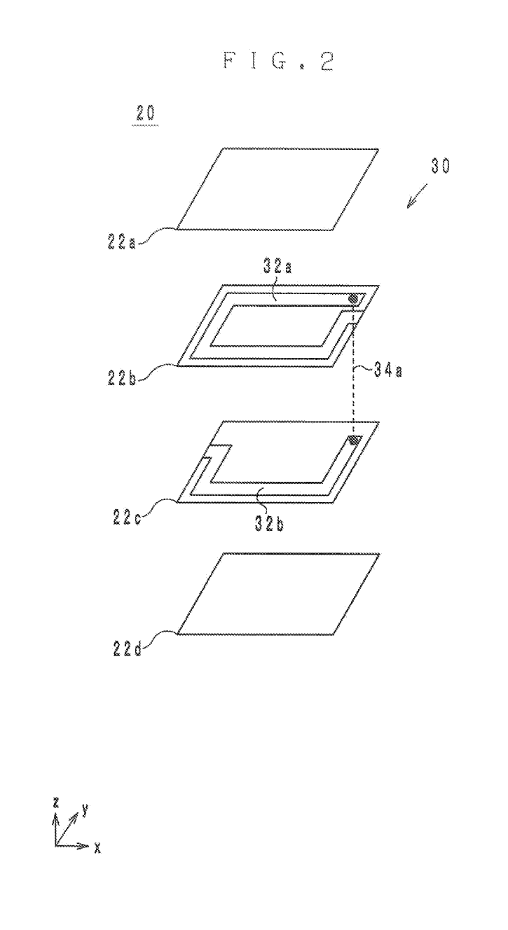

### See FIGS. 1 and 2

The structure of the inductor according to the embodiment is described with reference to the drawings. The inductor 1 is a laminated coil, and the direction of lamination is defined as a z-direction. A direction along the longer sides of the inductor when viewed from the z-direction is defined as an x-direction, and a direction along the shorter sides of the inductor when viewed from the z-direction is defined as a y-direction. The x-direction, y-direction and z-direction are perpendicular to one another.

The inductor 1 comprises a laminate body (sintered body) 20, a coil 30 and external electrodes 40a and 40b. As indicated in FIG. 1, the inductor 1 has a shape of a rectangular parallelepiped.

The laminate body 20 is a sintered body of a laminate of insulating layers 22a through 22d containing Z-type hexagonal ferrite as a main phase. As seen in FIG. 2, the insulating layers 22a through 22d, which are rectangular when viewed from the z-direction, are laminated in this order from a positive side to a negative side in the z-direction. In the following, the surface of each of the insulating layers 22a through 22d on the positive side in the z-direction is referred to as an upper surface.

As seen in FIG. 1, the external electrode 40a is provided to cover a surface of the laminate body 20 on a positive side in the x-direction and to extend to the adjacent surfaces. The external electrode 40b is provided to cover a surface of the laminate body 20 on a negative side in the x-direction and to extend to the adjacent surfaces. The external electrodes 40a and 40b are formed of a conductive material, for example, Au, Ag, Pd, Cu, Ni or the like.

As illustrated in FIG. 2, the coil 30 is located in the laminate body 20, and comprises coil conductors 32a and 32b, and a via-hole conductor 34a. The coil 30 is a spiral coil having a central axis extending in the z-direction. Thus, the coil 30 circles while moving in the direction of lamination. The coil 30 is formed of a conductive material, for example, Au, Ag, Pd, Cu, Ni or the like.

The coil conductor 32a is a linear conductor provided on the upper surface of the insulating layer 22b. The coil conductor 32a extends along the outer edges of the insulating layer 22b on both the positive and negative sides in the x-direction and along the outer edges of the insulating layer 22b on both the positive and negative sides in the y-direction. Accordingly, the coil conductor 32a forms a square when viewed from the z-direction. One end of the coil conductor 32a is exposed on the surface of the laminate body 20 through the outer edge of the insulating layer 22b on the positive side in the x-direction and is connected to the external electrode 40a. The other end of the coil conductor 32a, which is located near the corner of the insulating layer 22b at the intersection of the outer edge on the positive side in the x-direction and the outer edge on the positive side in the y-direction, is connected to the via-hole conductor 34a piercing the insulating layer 22b in the z-direction.

The coil conductor 32b is a linear conductor provided on the upper surface of the insulating layer 22c. The coil conductor 32b extends along the outer edges of the insulating layer 22c on both the positive and negative sides in the x-direction and the outer edge on the negative side in the y-direction. Accordingly, the coil conductor 32b is substantially U-shaped. One end of the coil conductor 32b, which is located near the corner of the insulating layer 22c at the intersection of the outer edge on the positive side in the x-direction and the outer edge on the positive side in the y-direction, is connected to the via-hole conductor 34a. The other end of the coil conductor 32b is exposed on the surface of the laminate body 20 through the outer edge of the insulating layer 22c on the negative side in the x-direction and is connected to the external electrode 40b.

### Production Method

Next, a production method of the inductor according to the embodiment is described.

First, ferrite green sheets are prepared for the insulating layers 22a through 22d. Specifically, a powder of BaCO₃, a powder of Co₃O₄ and a powder of Fe₂O₃, which have specific surface areas within a range from 2 m²/g to 20 m²/g, are prepared at a proper ratio by weight such that a mixture of the powders will contain Ba₃Co₂Fe₂₄O₄₁ (Z-type hexagonal ferrite) as a main component. These powders are put into a mill together with pure water, a dispersant and PSZ balls, and these materials are wet-milled and mixed for eight hours. The resultant mixture is evaporated and dried, and is calcined at 1250 degrees C. for five hours.

To the resultant calcined powder, Bi₂O₃, borosilicate glass (SiO₂.B₂O₃.R₂O) and silica glass (SiO₂) are added. In this regard, the additive ratio by weight of these additives to the calcined powder of Z-type hexagonal ferrite is 6:2:2:100. The calcined powder of Z-type hexagonal ferrite with the additives contained is put into a ball mill together with a dispersant and PSZ balls, and these materials are wet-milled and mixed for about 20 hours. Thereafter, the resultant mixture is dried and crashed, and a ferrite ceramic powder is obtained.

This ferrite ceramic powder is mixed with a binder (vinyl acetate, water-soluble acrylic or the like), a plasticizer, a wetter, a dispersant and a defoamer in a ball mill for about 30 minutes, and thereafter, undergoes reduced-pressure defoaming. Consequently, ceramic slurry is obtained. The ceramic slurry is spread over a carrier film to be formed into a sheet, and the sheet is dried. In this way, the ceramic green sheets are prepared for the insulating layers 22a through 22d.

Next, the green sheet for the insulating layer 22b is irradiated with a laser beam so that a via hole is made. Then, conductive paste consisting mainly of Au, Ag, Pd, Cu, Ni or the like is filled in the via hole, and thereby, the via-hole conductor 34a is formed. The step of filling the conductive paste in the via hole may be carried out simultaneously with a step of forming the coil conductors 32a and 32b, which will be described below.

After the formation of the via hole or after the formation of the via-hole conductor, conductive paste consisting mainly of Au, Ag, Pd, Cu, Ni or the like is applied onto the respective surfaces of the green sheets for the insulating layers 22b and 22c by screen printing. Thereby, the coil conductors 32a and 32b are formed.

Next, the green sheets for the insulating layers 22a through 22d are laminated in this order and are pressure-bonded together. Thereby, an unsintered mother laminate is obtained. The unsintered mother laminate undergoes isostatic pressing, whereby the sheets of the mother laminate are securely bonded together.

Thereafter, the mother laminate is cut by a cutting blade into laminate bodies 20 of a specified size. The unsintered laminate bodies 20 undergo debinding and firing. The debinding is carried out, for example, in a hypoxic atmosphere at 500 degrees C. for two hours. The firing is carried out, for example, within the temperature range from 800 degrees C. to 900 degrees C. for two hours and a half.

After the firing, each of the laminate bodies 20 is chamfered by barrel polishing.

On the chamfered laminate body 20, the external electrodes 40a and 40b are formed. First, electrode paste of a conductive material consisting mainly of Ag is applied on the surface of the laminate body 20. Next, the applied electrode paste is baked at a temperature of about 800 degrees C. for one hour. Thereby, underlayers are formed respectively for the external electrodes 40a and 40b.

Lastly, the underlayers are plated with Ni/Sn, and consequently, the external electrodes 40a and 40b are formed. Through the process above, the inductor 1 is produced.

### Advantageous Effects

During the production process of the laminate body (sintered body) 20, Bi₂O₃, borosilicate glass and silica glass are added to calcined powder of Z-type hexagonal ferrite. In this regard, the additive ratio by weight of Bi₂O₃, borosilicate glass and silica glass to the calcined powder of Z-type hexagonal ferrite is 6:2:2:100. This allows low-temperature sintering of the laminate body 20 and reduces the temperature-dependency of the inductance value and the Q-value of the laminate body 20 and the inductor 1 employing the laminate body 20.

The inventors conducted a first experiment to examine the relationship between the additive amount of Bi₂O₃ to the laminate body (sintered body) 20 and the temperature-dependency of the inductance of the laminate body 20. For the first experiment, the inductor 1 was prepared as a first sample. An inductor with the same structure as the inductor 1 of which a sintered body was made of a ferrite ceramic powder wherein the additive ratio by weight of Bi₂O₃ to the calcined powder of Z-type hexagonal ferrite was 4:100 was prepared as a second sample. An inductor with the same structure as the inductor 1 of which a sintered body was made of a ferrite ceramic powder wherein the additive ratio by weight of Bi₂O₃ to the calcined powder of Z-type hexagonal ferrite was 5:100 was prepared as a third sample. An inductor with the same structure as the inductor 1 of which a sintered body was made of a ferrite ceramic powder wherein the additive ratio by weight of Bi₂O₃ to the calcined powder of Z-type hexagonal ferrite was 7:100 was prepared as a fourth sample. An inductor with the same structure as the inductor 1 of which a sintered body was made of a ferrite ceramic powder wherein the additive ratio by weight of Bi₂O₃ to the calcined powder of Z-type hexagonal ferrite was 8:100 was prepared as a fifth sample.

While an alternating current was applied to each of the samples, the inductance value L₍₋₄₀₎ at the temperature of −40 degrees C., the inductance value L₍₂₀₎ at the temperature of 20 degrees C. and the inductance value L₍₁₂₅₎ at the temperature of 125 degrees C. were measured. With regard to each of the samples, from the measured inductance values, changes in inductance with changes in temperature, that is, the temperature-dependency of inductance was derived. Specifically, with regard to each of the samples, the ratio of the amount of change in inductance with a temperature change from 20 degrees C. to −40 degrees C. (ΔL/L_{(-40˜20)}) was calculated as follows.

ΔL/L_{(-40˜20)}=(L₍₋₄₀₎−L₍₂₀₎)/L₍₂₀₎×100 (1)

Also, the ratio of the amount of change in inductance with a temperature change from 20 degrees C. to 125 degrees C. (ΔL/L_{(125˜20)}) was calculated as follows.

ΔL/L_{(125˜20)}˜(L₍₁₂₅₎−L₍₂₀₎)/L₍₂₀₎×100 (1)

In addition, in order to check whether each of the samples was completely sintered, the sintered density of each of the samples was measured by the Archimedes method. In this regard, when the sintered density was equal to or greater than 4.70 g/cm³, the sample was judged to have been completely sintered. Table 1 below indicates the ratios of the amounts of changes in inductance with the temperature changes and the sintered density with regard to each of the samples.

TABLE 1

| | | | | Ratio of amount of | | |
|---|---|---|---|---|---|---|
| | | | | change in inductance with | | |
| | | Borosilicate | | temperature change | | Sintered |
| | Bi₂O₃ | glass | Silica glass | −40~20° C. | 20~125° C. | density |
| | Ratio by WT | Ratio by WT | Ratio by WT | % | % | g/cm³ |
| Sample 2 | 4 | 2 | 2 | −2.5 | 6.8 | 3.24 |
| Sample 3 | 5 | 2 | 2 | −1.2 | 2.1 | 4.75 |
| Sample 1 | 6 | 2 | 2 | −0.5 | 0.8 | 4.86 |
| Sample 4 | 7 | 2 | 2 | −1.4 | 1.9 | 4.92 |
| Sample 5 | 8 | 2 | 2 | −3.6 | 7.2 | 5.02 |

As is apparent from Table 1, with regard to each of the first, third and fourth samples wherein the additive ratio by weight of Bi₂O₃ to the calcined powder of Z-type hexagonal ferrite was within the range from 5:100 to 7:100, the ratios of the amounts of changes in inductance with the temperature changes were within ±5%, and these samples have inductance lowly dependent on temperature. On the other hand, with regard to each of the second sample wherein the additive ratio by weight of Bi₂O₃ to the calcined powder of Z-type hexagonal ferrite was 4:100 and the fifth sample wherein the additive ratio by weight of Bi₂O₃ to the calcined powder of Z-type hexagonal ferrite was 8:100, the ratio of the amount of change in inductance with the temperature change from 20 degrees C. to 125 degrees C. was beyond 5%, and these samples have inductance highly dependent on temperature.

The sintered density of the second sample was 3.24 g/cm³, which shows that the second sample had not been sintered completely. The reason is as follows. The additive amount of the Bi₂O₃ in the second sample was smaller than those in the other samples, and accordingly the sintering temperature of the second sample was higher than those of the other samples.

Further, the inventors conducted a second experiment to examine the relation between the additive amount of glass materials and the temperature-dependency of inductance. For the second experiment, an inductor with the same structure as the inductor 1 of which a sintered body was made of a ferrite ceramic powder wherein no borosilicate glass was added was prepared as a sixth sample. An inductor with the same structure as the inductor 1 of which a sintered body was made of a ferrite ceramic powder wherein the additive ratio by weight of borosilicate glass to the calcined powder of Z-type hexagonal ferrite was 3:100 was prepared as a seventh sample. An inductor with the same structure as the inductor 1 of which a sintered body was made of a ferrite ceramic powder wherein the additive ratio by weight of borosilicate glass to the calcined powder of Z-type hexagonal ferrite was 4:100 was prepared as an eighth sample. An inductor with the same structure as the inductor 1 of which a sintered body was made of a ferrite ceramic powder wherein no silica glass was added was prepared as a ninth sample. An inductor with the same structure as the inductor 1 of which a sintered body was made of a ferrite ceramic powder wherein the additive ratio by weight of silica glass to the calcined powder of Z-type hexagonal ferrite was 3:100 was prepared as a tenth sample. An inductor with the same structure as the inductor 1 of which a sintered body was made of a ferrite ceramic powder wherein the additive ratio by weight of silica glass to the calcined powder of Z-type hexagonal ferrite was 4:100 was prepared as an eleventh sample.

While an alternating current was applied to each of the samples, the inductance value L₍₋₄₀₎ at the temperature of −40 degrees C., the inductance value L₍₂₀₎ at the temperature of 20 degrees C. and the inductance value L₍₁₂₅₎ at the temperature of 125 degrees C. were measured. With regard to each of the samples, the ratios of the amounts of changes in inductance with temperature changes were calculated by using the expressions (1) and (2) above. In addition, in the second experiment also, the sintered density of each of the samples was measured. Tables 2 and 3 below indicate the ratios of the amounts of changes in inductance with the temperature changes and the sintered density with regard to each of the samples. Table 2 indicates the ratios of the amounts of changes in inductance with the temperature changes and the sintered density with regard to each of the sixth through eighth samples. Table 3 indicates the ratios of the amounts of changes in inductance with the temperature changes and the sintered density with regard to each of the ninth through eleventh samples. For comparison, the results with regard to the first sample are also listed in Tables 2 and 3.

TABLE 2

| | | | | Ratio of amount of | | |
|---|---|---|---|---|---|---|
| | | | | change in inductance with | | |
| | | Borosilicate | | temperature change | | Sintered |
| | Bi₂O₃ | glass | Silica glass | −40~20° C. | 20~125° C. | density |
| | Ratio by WT | Ratio by WT | Ratio by WT | % | % | g/cm³ |
| Sample 6 | 6 | 0 | 2 | −4.6 | 4.8 | 4.92 |
| Sample 1 | 6 | 2 | 2 | −0.5 | 0.8 | 4.86 |
| Sample 7 | 6 | 3 | 2 | 1.1 | −2.4 | 4.75 |
| Sample 8 | 6 | 4 | 2 | 6.2 | −7.8 | 4.12 |

TABLE 3

| | | | | Ratio of amount of | | |
|---|---|---|---|---|---|---|
| | | | | change in inductance with | | |
| | | Borosilicate | | temperature change | | Sintered |
| | Bi₂O₃ | glass | Silica glass | −40~20° C. | 20~125° C. | density |
| | Ratio by WT | Ratio by WT | Ratio by WT | % | % | g/cm³ |
| Sample 9 | 6 | 2 | 0 | −4.8 | 4.6 | 5.06 |
| Sample 1 | 6 | 2 | 2 | −0.5 | 0.8 | 4.86 |
| Sample 10 | 6 | 2 | 3 | 4.0 | −4.2 | 4.71 |
| Sample 11 | 6 | 2 | 4 | 6.9 | −8.2 | 3.98 |

As is apparent from Tables 2 and 3, with regard to each of the first, sixth, seventh, ninth and tenth samples wherein the additive ratio by weight of the total of borosilicate glass and silica glass to the calcined powder of Z-type hexagonal ferrite was within the range from 2:100 to 5:100, the ratios of the amounts of changes in inductance with the temperature changes were within ±5%. On the other hand, with regard to each of the eighth and eleventh samples wherein the additive ratio by weight of the total of borosilicate glass and silica glass to the calcined powder of Z-type hexagonal ferrite was within the range from 6:100 to 8:100, the ratios of the amounts of changes in inductance with the temperature changes were beyond ±5%. Therefore, it is preferred that the additive ratio of the total of borosilicate glass and silica glass to the calcined powder of Z-type hexagonal ferrite is within the range from 2:100 to 5:100.

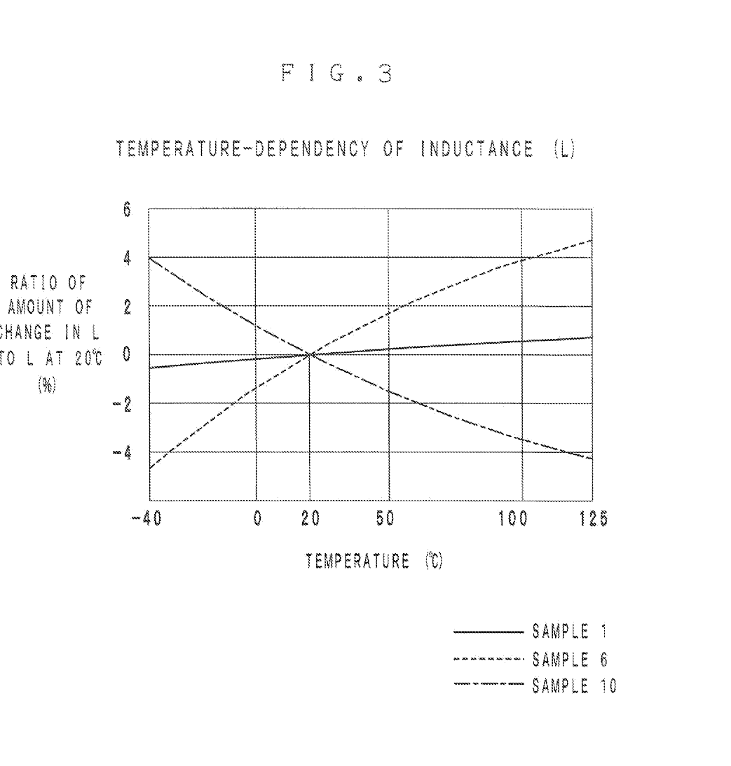

Further, the inventors charted changes in inductance with changes in temperature with regard to each of the first, sixth and tenth samples as the graph in FIG. 3, based on the ratios of the amounts of changes with the temperature changes indicated in Tables 1, 2 and 3. In the graph of FIG. 3, the solid line indicates changes in inductance with changes in temperature with regard to the first sample. The broken line indicates changes in inductance with changes in temperature with regard to the sixth sample. The alternate long and short dash line indicates changes in inductance with changes in temperature with regard to the tenth sample.

As is apparent from FIG. 3, with regard to the sixth sample wherein the additive ratio by weight of the total of the glass materials to the calcined powder of Z-type hexagonal ferrite was 2:100, the inductance becomes greater with rises in temperature. With regard to the first sample wherein the additive ratio by weight of the total of the glass materials to the calcined powder of Z-type hexagonal ferrite was 4:100, the inductance becomes greater only a little with rises in temperature. With regard to the tenth sample wherein the additive ratio by weight of the total of the glass materials to the calcined powder of Z-type hexagonal ferrite was 5:100, which is higher than that of the first sample by only one part per hundred by weight, the inductance becomes lower with rises in temperature. It is assumable from the graph of FIG. 3 that an increase in the additive ratio of the glass materials reduces the slope representing the rate of changes in inductance with rises in temperature.

The laminate body 20 contains borosilicate glass and silica glass. By adding silica glass, it is possible to reduce the dielectric constant of the laminate body 20, which is advantageous when the laminate body 20 is used for a high-frequency component. By adding borosilicate glass, it is possible to maintain the sintering temperature of the laminate body (sintered body) 20 at a low temperature because the melting point of borosilicate glass is low. Thus, since the laminate body 20 contains both borosilicate glass and silica glass, the laminate body 20 has good effects both in the dielectric constant and the sintering temperature.

### Other Embodiments

Sintered bodies and inductors according to the present disclosure are not limited to the embodiment above. For example, the glass material to be added to the calcined powder of Z-type hexagonal ferrite is not necessarily a mixture of borosilicate glass and silica glass. Only either borosilicate glass or silica glass may be added.

Although the present disclosure has been described in connection with the embodiment above, it is to be noted that various changes and modifications may be obvious to those who are skilled in the art. Such changes and modifications are to be understood as being within the scope of the present disclosure.

What is claimed is:

1. A sintered body comprising:
Z-type hexagonal ferrite, Bi₂O₃, and a glass material as starting materials;
wherein an additive ratio by weight of the Bi₂O₃ to the Z-type hexagonal ferrite in the starting materials is within a range from 5:100 to 7:100; and
wherein the sintered body is obtained by sintering of the starting materials and contains the Z-type hexagonal ferrite as a main phase.

2. The sintered body according to claim 1, wherein the glass material is borosilicate glass.

3. The sintered body according to claim 1, wherein the glass material is silica glass.

4. The sintered body according to claim 1, wherein the glass material is a mixture of borosilicate glass and silica glass.

5. The sintered body according to claim 1, wherein an additive ratio by weight of the glass material to the Z-type hexagonal ferrite in the starting materials is within a range from 2:100 to 5:100.

6. An inductor comprising the sintered body according to claim 1.
